(19) United States
(12) Patent Application Publication
(10) Pub. No.: US 2025/0333121 A1
(43) Pub. Date: Oct. 30, 2025

(54) AERODYNAMIC SKIRT AND VEHICLE

(71) Applicant: ZF CV Systems Europe BV, Brussels (BE)

(72) Inventor: Adrian Pochojka, Wroclaw (PL)

(21) Appl. No.: 19/186,217

(22) Filed: Apr. 22, 2025

(30) Foreign Application Priority Data
Apr. 25, 2024 (EP) 24172506.8

(51) Int. Cl. B62D 35/00; B62D 27/02

(52) U.S. Cl. CPC B62D 35/001; B62D 27/02

(57) ABSTRACT

The disclosure relates to an aerodynamic skirt for a vehicle, in particular for a trailer or a tractor-trailer-combination. The aerodynamic skirt includes a mounting orientation defining an orientation of the aerodynamic skirt with respect to a driving direction of the vehicle. The aerodynamic skirt includes a panel, which is arranged at least essentially vertically when the aerodynamic skirt is mounted in the mounting orientation. The panel includes a bottom end with respect to the mounting orientation. The aerodynamic skirt includes a protrusion at the bottom end of the aerodynamic skirt. The protrusion is arranged transversely with respect to the panel.

### CROSS-REFERENCE TO RELATED APPLICATIONS

This application claims priority of European patent application no. 24172506.8, filed Apr. 25, 2024, the entire content of which is incorporated herein by reference.

### TECHNICAL FIELD

The disclosure relates to an aerodynamic skirt for a vehicle and to a vehicle.

### BACKGROUND

An aerodynamic skirt for a trailer, also known as a trailer skirt or side fairing, is a device attached to the sides and sometimes the rear of a vehicle, such as a semi-trailer truck. It serves the purpose of reducing aerodynamic drag, which in turn improves fuel efficiency and reduces emissions.

These skirts are typically made of lightweight, flexible materials such as plastic or composite materials. They extend downward from the bottom of a chassis of the trailer, creating a smooth surface that helps to direct airflow around the trailer more efficiently. By reducing the turbulence created by air hitting the underside of the trailer and the gap between the trailer and the road, aerodynamic skirts help to decrease the drag force acting on the vehicle.

The reduction in aerodynamic drag results in less energy required to propel the truck forward, leading to improved fuel efficiency. This is particularly important for long-haul trucking operations where fuel costs represent a significant portion of operating expenses. Improved fuel efficiency means reduced carbon dioxide emissions and other pollutants associated with burning fossil fuels. This helps companies meet environmental regulations and reduce their carbon footprint. Lower fuel consumption translates to cost savings for trucking companies over the long term. Despite the initial investment in purchasing and installing aerodynamic skirts, the fuel savings often outweigh the upfront costs, resulting in a positive return on investment. In some regions, there are regulations mandating the use of aerodynamic devices on commercial trucks to improve fuel efficiency and reduce emissions. Therefore, using aerodynamic skirts ensures compliance with these regulations.

Existing solutions are based mainly on straight skirts in a form of one single element or multiple segments without any additional elements attached to them. Sometimes, the aerodynamic skirts are corrugated to add stiffness. However, the aerodynamics are still not ideal.

### SUMMARY

It is an object of the disclosure to improve the aerodynamics of a vehicle, in particular of a trailer or a tractor-trailer combination.

The object is, for example, achieved by an aerodynamic skirt by various embodiments of the disclosure.

The aerodynamic skirt is configured for a vehicle, in particular for a trailer or a tractor-trailer-combination. The aerodynamic skirt includes a mounting orientation defining an orientation of the aerodynamic skirt with respect to a driving direction of the vehicle. The aerodynamic skirt includes a panel, which is arranged at least essentially vertically when the aerodynamic skirt is mounted in the mounting orientation. The panel includes a bottom end with respect to the mounting orientation. The aerodynamic skirt includes a protrusion at the bottom end of the aerodynamic skirt, wherein the protrusion is arranged transversely with respect to the panel.

The inventor has discovered that existing aerodynamic skirts have a remaining drawback in that air tends to wrap around the bottom edge of the aerodynamic skirt, which increases the amount of air that flows under the vehicle and adds pressure to the vehicle chassis and wheels. The effect is similar to the situation at a wingtip of a plane, which creates a vortex of flowing air. The amount of air that flows beneath the aerodynamic skirt's bottom edge is increased due to the pressure difference between upwind and downwind side of the aerodynamic skirt. As a result of this pressure difference, a strong vortex wraps around the edge. The vortex causes the fresh air from outside to flow beneath the bottom edge of the panel and under the vehicle. This eventually increases the pressure at the chassis and wheels of the trailer, which increases the drag.

The protrusion has an effect that is similar to the effect of a device known in aerospace engineering called winglet or sharklet. That is, the protrusion reduces the vortex and, thus, reduces the amount of air flowing beneath the panel's bottom end and under the vehicle. This reduces the pressure against the chassis and the wheels and, thus, reduces the vehicle's overall resistance to airflow. This increases fuel efficiency.

According to an embodiment, the protrusion is formed by a plate, which is arranged transversely with respect to the panel. A plate is a simple and yet effective kind of protrusion. The plate can form an endplate of the aerodynamic skirt.

According to an embodiment, the protrusion is segmented with respect to the driving direction. This provides for an effective reduction of air flow under the vehicle, while only a small amount of material needs to be provided for the protrusion.

According to an embodiment, the protrusion is formed continuously with respect to the driving direction. This provides for an effective reduction of airflow under the vehicle, while manufacturing and handling of the aerodynamic skirt are simple.

The protrusion is generally arranged at an angle with respect to the panel, as the protrusion is arranged transversely with respect to the panel. The angle can in particular be larger than 45°, in particular larger than 70°, in particular larger than 85°. In an embodiment, the protrusion is arranged at least essentially orthogonally with respect to the panel and/or essentially horizontally when the aerodynamic skirt is mounted in the mounting orientation. This provides for an effective reduction of airflow under the vehicle.

The protrusion can generally be an inward protrusion or an outward protrusion with respect to the mounting orientation. An aerodynamic skirt is typically arranged at a peripheral position at the vehicle. Thus, the terms “inward” and “outward” refer to a direction from the peripheral position towards a center of the vehicle and a direction from the peripheral position away from the center of the vehicle, respectively.

According to an embodiment, the aerodynamic skirt includes an inward protrusion and an outward protrusion, both arranged at the bottom end of the panel and arranged transversely with respect to the panel. This further reduces the amount of air flowing under the vehicle. All embodiments described with respect to one protrusion can apply—where meaningful—to either one of the inward protrusion and the outward protrusion or to both the inward protrusion and the outward protrusion.

The inward protrusion and the outward protrusion can be configured symmetrically or asymmetrically with respect to the panel. Symmetrically arranged protrusions provide for a simple construction. Asymmetrically arranged protrusions provide for a more sophisticated manipulation of the airflow.

According to an embodiment, the panel includes a length with respect to the driving direction, the protrusion includes a length with respect to the driving direction, and the length of the protrusion is smaller than the length of the panel. This provides for an effective reduction of air flow under the vehicle, while only a small amount of material needs to be provided for the protrusion. A ratio of the length of the protrusion and the length of the panel can in particular be at least 1/5, in particular at least 1/3, in particular at least 2/3. A ratio of the length of the protrusion and the length of the panel can in particular be at most 4/5, in particular at most 2/3, in particular at most 1/3.

The protrusion can, for example, be positioned at a front end of the panel, at a rear end of the panel, or spaced apart from both a front end of the panel and a rear end of the panel.

According to another embodiment, the protrusion extends along a full length of the panel. This provides for an effective reduction of air flow under the vehicle.

According to an embodiment, the panel includes a first portion, which is arranged at least essentially in parallel to the driving direction. This further reduces airflow under the vehicle.

According to an embodiment, the panel includes a second portion, which converges forwardly with respect to the driving direction. This further reduces airflow under the vehicle.

The ordinal numbers used herein merely simplify reference and are not limiting with respect to the total number of elements for which the ordinal numbers are used. In particular, the existence of the second portion does not necessarily mean that a first portion arranged at least essentially parallel to a driving direction exists.

According to an embodiment, the protrusion is attached to the panel by a welded connection. This provides for a simple and yet solid connection.

According to an embodiment, the protrusion is formed as one piece with the panel. According to an embodiment, the protrusion is formed by cold forming, in particular by bending. These embodiments provide for simple and yet solid connections.

The aforementioned object is, for example, also achieved by a vehicle according to the disclosure. The vehicle can in particular be a trailer or a tractor-trailer combination. The vehicle includes an aerodynamic skirt as described above.

The vehicle can include a chassis. According to an embodiment, the aerodynamic skirt is positioned under the chassis. This provides for an advantageous aerodynamic setup.

The vehicle can include a rear axle aggregate, which includes at least one axle. According to an embodiment, the aerodynamic skirt is positioned in front of the rear axle aggregate with respect to the driving direction. This provides for an advantageous aerodynamic setup.

The vehicle can be, for example, a commercial vehicle, a truck, a passenger car or a bus. The vehicle can be, for example, a road vehicle or a rail vehicle. The vehicle can be, for example, a single vehicle, a tractor for a tractor-trailer combination, a trailer for a tractor-trailer combination, or a tractor-trailer combination. The trailer of or for the tractor-trailer combination can, for example, be a semi-trailer or a full trailer.

### BRIEF DESCRIPTION OF DRAWINGS

The invention will now be described with reference to the drawings wherein:

FIG. 1 shows a vehicle including an aerodynamic skirt in a side view.

FIG. 2 shows the vehicle of FIG. 1 in a perspective view.

FIG. 3 shows the vehicle of FIGS. 1-2 in another perspective view.

FIG. 4 shows the vehicle of FIGS. 1 to 3 in another perspective view.

FIG. 5 shows the vehicle of FIGS. 1 to 4 in another perspective view.

FIG. 6 shows the vehicle of FIGS. 1 to 5 in another perspective view.

FIG. 7 shows an aerodynamic skirt.

FIG. 8 shows an aerodynamic skirt.

FIG. 9 shows an aerodynamic skirt.

FIG. 10 shows an aerodynamic skirt.

FIG. 11 shows an aerodynamic skirt.

FIG. 12 shows an aerodynamic skirt.

FIG. 13 shows an aerodynamic skirt.

FIG. 14 shows an aerodynamic skirt.

FIG. 15 shows an aerodynamic skirt.

### DETAILED DESCRIPTION

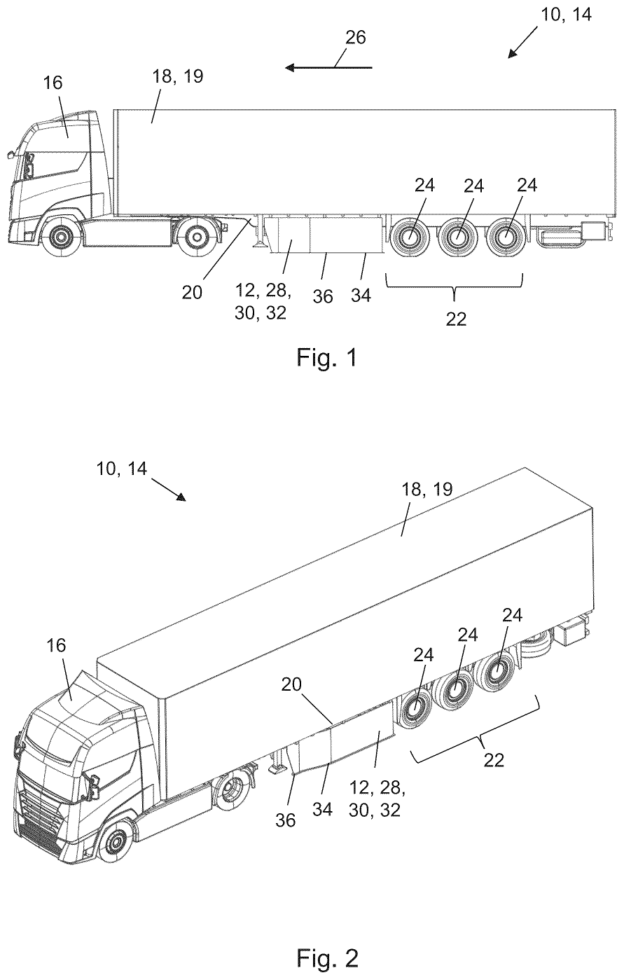

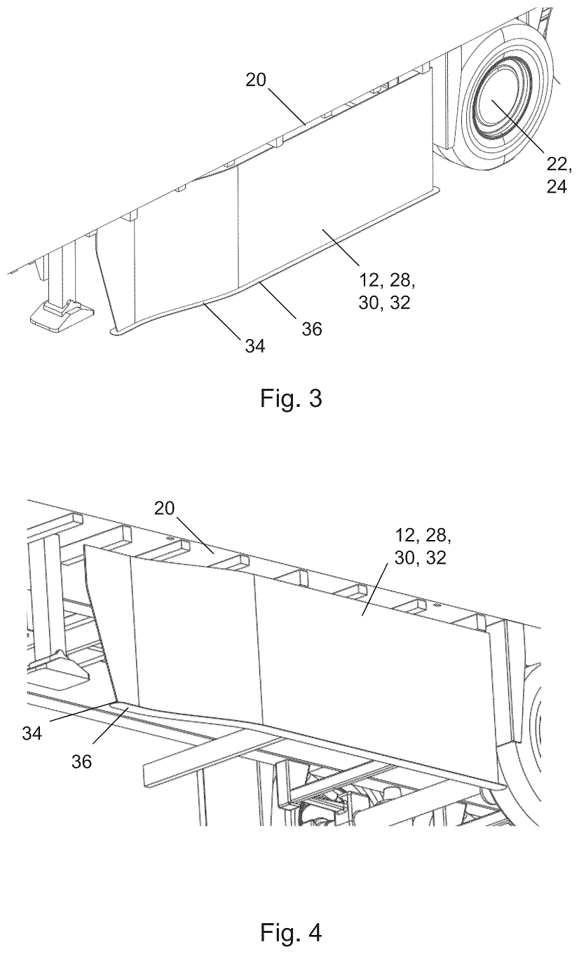

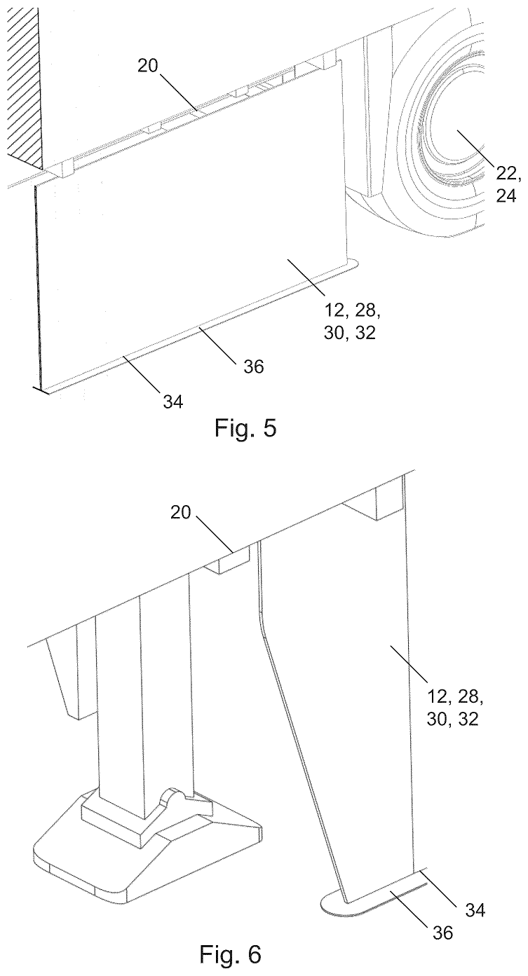

FIGS. 1 to 6 show different views of a vehicle 10 including an aerodynamic skirt 12. FIGS. 1 to 6 will be described together unless reference is made to a specific one of FIGS. 1 to 6.

The vehicle 10 of FIGS. 1 to 6 is, in this example, configured as a tractor-trailer combination 14 and includes a tractor 16 and a trailer 18. Specifically, the trailer 18 is configured as a semi-trailer 19 in this example.

The vehicle 10 includes a chassis 20, wherein the aerodynamic skirt 12 is positioned under this chassis 20.

The vehicle 10 includes a rear axle aggregate 22. The rear axle aggregate 22 includes, in this example, three axles 24. The aerodynamic skirt 12 is positioned in front of the rear axle aggregate 22 with respect to a driving direction 26 of the vehicle 10 indicated as an arrow in FIG. 1.

The aerodynamic skirt 12 of the vehicle 10 of FIGS. 1 to 6 includes a mounting orientation 28 as shown defining an orientation 30 of the aerodynamic skirt 12 with respect to a driving direction 26 of the vehicle 10.

The aerodynamic skirt 12 includes a panel 32, which is arranged at least essentially vertically when the aerodynamic skirt 12 is mounted in the mounting orientation 28 as shown. The panel 32 includes a bottom end 34 with respect to the mounting orientation 28. The aerodynamic skirt 12 includes a protrusion 36 at the bottom end 34 of the aerodynamic skirt 12. The protrusion 36 is arranged transversely with respect to the panel 32.

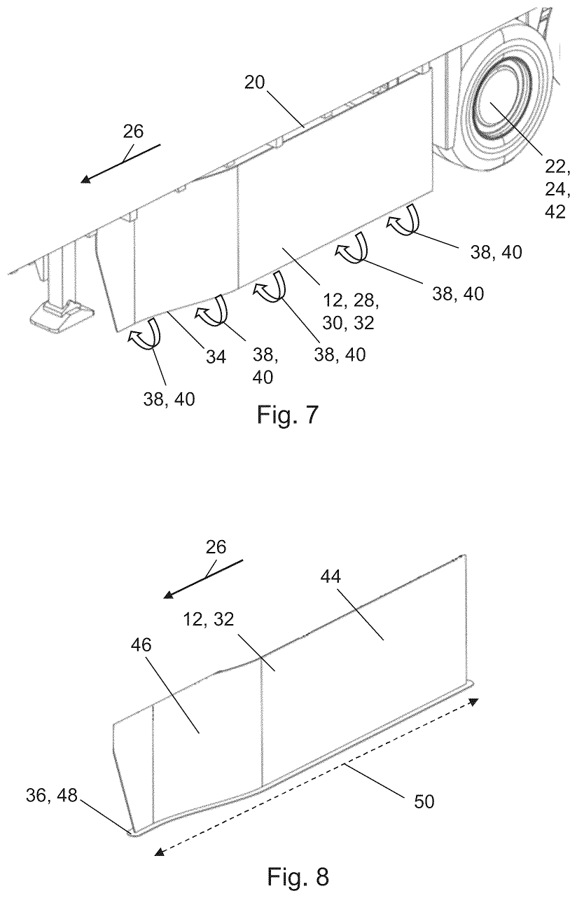

FIG. 7 shows a vehicle 10 including an aerodynamic skirt 12, which includes a mounting orientation 28 defining an orientation 30 of the aerodynamic skirt 12 with respect to a driving direction 26 of the vehicle 10. The aerodynamic skirt 12 includes a panel 32, which is arranged at least essentially vertically when the aerodynamic skirt 12 is mounted in the mounting orientation 28. The panel 32 includes a bottom end 34 with respect to the mounting orientation 28. Thus, the aerodynamic skirt 12 of FIG. 7 is similar to the one shown in FIGS. 1 to 6 but differs in that there is no protrusion at the bottom end 34 of the panel 32.

The aerodynamic skirt 12 of FIG. 7 without a protrusion has a drawback in that air 38 wraps around the bottom end 34 of the aerodynamic skirt 12 and increases the amount of air 38 that flows under the vehicle 10 and adds pressure to the vehicle chassis 20 and wheels 42. The effect is similar to the situation at a wingtip of a plane, which creates a vortex. The amount of air 38 that flows beneath the bottom end 34 of the aerodynamic skirt 12 is increased due to the pressure difference between the upwind and downwind sides of the aerodynamic skirt 12. As a result of this pressure difference, a vortex 40 wraps around the bottom end 34. The vortex 40 causes the fresh air 38 from outside to flow beneath the bottom end 34 of the panel 32 and under the vehicle 10. This eventually increases the pressure on the chassis 20 and wheels 42 of the vehicle 10, which increases the vehicle's overall resistance to headwind.

The protrusion 36 shown in FIGS. 1 to 6 has an effect that is similar to the effect of a device known in aerospace engineering called winglet or sharklet. That is, the protrusion 36 reduces the vortex 40 and, thus, reduces the amount of air 38 flowing beneath the bottom end 34 of the panel 32 and under the vehicle 10. This reduces the pressure against the chassis 20 and the wheels 42 and, thus, the overall resistance to headwind.

FIG. 8 shows an aerodynamic skirt 12, which includes a similar configuration to the one of FIGS. 1 to 6. A panel 32 of the aerodynamic skirt 12 includes a first portion 44, which is arranged at least essentially parallel to a driving direction 26. The panel 32 includes a second portion 46, which converges forwardly with respect to the driving direction 26.

The aerodynamic skirt 12 of FIG. 8 includes a protrusion 36 that is formed by a plate 48, which is arranged transversely with respect to the panel 32. In this example, the plate 48 is arranged horizontally, that is, orthogonally with respect to the panel 32.

The protrusion 36 of the aerodynamic skirt 12 of FIG. 8 extends along a full length 50 of the panel 32.

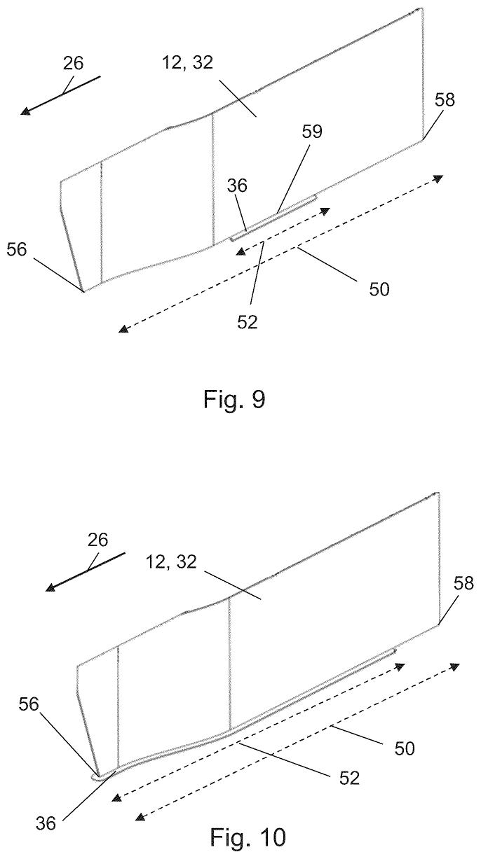

FIGS. 9 and 10 each show an aerodynamic skirt 12, wherein the panel 32 includes a length 50 with respect to the driving direction 26, wherein the protrusion 36 includes a length 52 with respect to the driving direction 26, wherein the length 52 of the protrusion 36 is smaller than the length 50 of the panel 32. A ratio of the length 52 of the protrusion 36 and the length 50 of the panel 32 can in particular be at least 1/5, in particular at least 1/3, in particular at least 2/3. The ratio of the length 52 of the protrusion 36 and the length 50 of the panel 32 can in particular be at most 4/5, in particular at most 2/3, in particular at most 1/3.

The protrusion 36 can be positioned at a front end 56 of the panel 32, at a rear end 58 of the panel 32, or spaced apart from both a front end 56 of the panel 32 and a rear end 58 of the panel 32.

In the example shown in FIG. 9, the ratio of the length 52 of the protrusion 36 and the length 50 of the panel 32 is about 2/7 or 0.28, that is, above 1/5 and below 1/3. In FIG. 9, the protrusion 36 is spaced apart from both the front end 56 of the panel 32 and the rear end 58 of the panel 32. The protrusion 36 is positioned essentially at a center 59 of the panel 32 with respect to the driving direction 26.

In the example of FIG. 10, the ratio of the length 52 of the protrusion 36 and the length 50 of the panel 32 is about 9/10 or 0,90. The protrusion 36 of FIG. 10 is positioned at a front end 56 of the panel 32.

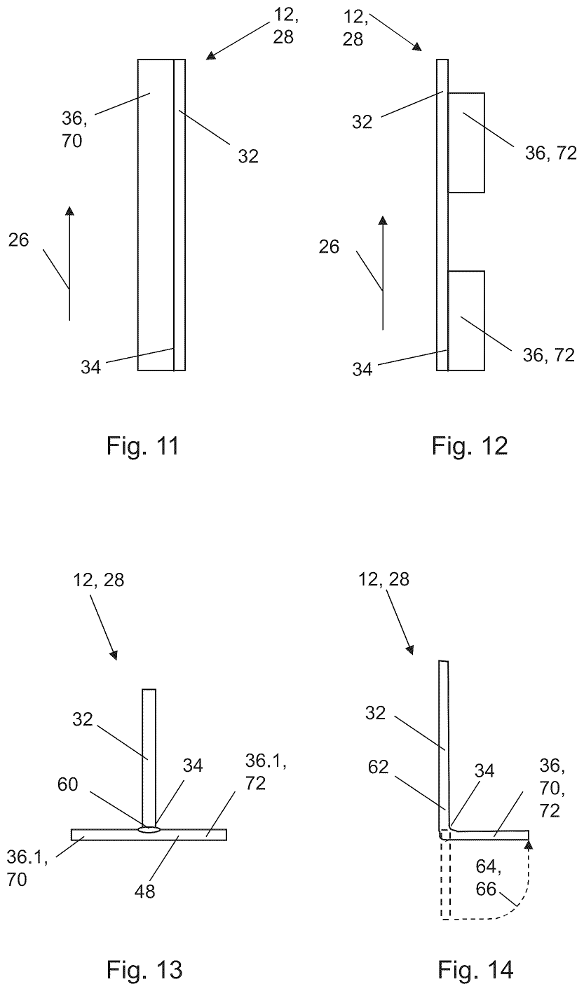

FIG. 11 shows an aerodynamic skirt 12 from the top when mounted in the mounting orientation. A protrusion 36 arranged at a bottom end 34 of a panel 32 of the aerodynamic skirt 12 is formed continuously with respect to the driving direction 26.

FIG. 12 shows an aerodynamic skirt 12 from the top when mounted in the mounting orientation. A protrusion 36 arranged at a bottom end 34 of a panel 32 of the aerodynamic skirt 12 is segmented with respect to the driving direction 26.

FIG. 13 shows an aerodynamic skirt 12 having a first protrusion 36.1 and a second protrusion 36.2, wherein the protrusions 36 are attached to the panel 32 by a welded connection 60. In this example, the protrusions 36 are formed by a plate 48.

FIG. 14 shows an aerodynamic skirt 12 having a protrusion 36 that is formed as one piece 62 with the panel 32, for example by cold forming 64, in particular by bending 66.

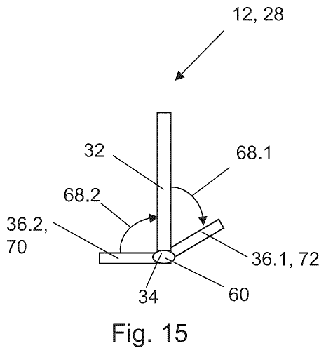

In general, the protrusion 36 is arranged transversely and, thus, at an angle with respect to the panel 32. The angle is indicated in FIG. 15 as angle 68. FIG. 15 shows an aerodynamic skirt 12 having a first protrusion 36.1 that is arranged at an angle 68.1 with respect to the panel 32. The angle 68.1 is about 60° in this example. The aerodynamic skirt 12 includes a second protrusion 36.2 that is arranged at an angle 68.2 of 90° with respect to the panel 32, that is, orthogonally with respect to the panel 32, and horizontally when the aerodynamic skirt 12 is mounted in the mounting orientation 28.

In general, the aerodynamic skirt 12 can include different numbers and kinds of protrusions, for example protrusions 36 such as shown in FIGS. 8 to 15. The protrusion 36 of an aerodynamic skirt 12 can be an inward protrusion 70 or an outward protrusion 72 with respect to the mounting orientation 28.

The aerodynamic skirts 12 of FIGS. 13 and 15, for example, each include an inward protrusion 70 and an outward protrusion 72, both arranged at the bottom end 34 of the panel 32 and arranged transversely with respect to the panel 32. In FIG. 13, the inward protrusion 70 and the outward protrusion 72 of the aerodynamic skirt 12 are configured symmetrically with respect to the panel 32. In FIG. 15, the inward protrusion 70 and the outward protrusion 72 of the aerodynamic skirt 12 are configured asymmetrically with respect to the panel 32.

The aerodynamic skirts 12 of FIGS. 11, 12, and 14, for example, each include a protrusion 36 only to one side of the panel 32, that is, either an inward projection 70 and an outward projection 72.

As will be apparent, in FIGS. 11 to 15 the inward protrusion 70 is oriented toward the left of the panel 32 and the outward protrusion 72 is oriented to the right of the panel 32, but this convention is used here for the sake of simplicity and the shown aerodynamic skirts 12 could be configured the opposite way.

It is understood that the foregoing description is that of the preferred embodiments of the invention and that various changes and modifications may be made thereto without departing from the spirit and scope of the invention as defined in the appended claims.

### LIST OF REFERENCES (PART OF THE DESCRIPTION)

10 vehicle
12 aerodynamic skirt
14 tractor-trailer-combination
16 tractor
18 trailer
19 semi-trailer
20 chassis
22 rear axle aggregate
24 axle
26 driving direction
28 mounting orientation
30 orientation
32 panel
34 bottom end
36 protrusion
38 air
40 vortex
42 wheels
44 first portion
46 second portion
48 plate
50 length of the panel
52 length of the protrusion
56 front end
58 rear end
59 center
60 welded connection
62 piece
64 cold forming
66 bending
68 angle
70 inward protrusion
72 outward protrusion

1. An aerodynamic skirt for a vehicle, the aerodynamic skirt comprising:
a panel;
the aerodynamic skirt being configured to be mounted in a mounting orientation defining an orientation of the aerodynamic skirt with respect to a driving direction of the vehicle;
said panel being arranged vertically when the aerodynamic skirt is mounted in the mounting orientation;
said panel including a bottom end with respect to the mounting orientation; and,
a protrusion at said bottom end arranged transversely with respect to said panel.

2. The aerodynamic skirt of claim 1, wherein said protrusion is formed by a plate arranged transversely with respect to said panel.

3. The aerodynamic skirt of one of claim 1, wherein said protrusion is segmented with respect to the driving direction.

4. The aerodynamic skirt of claim 1, wherein said protrusion is formed continuously with respect to the driving direction.

5. The aerodynamic skirt of claim 1, wherein said protrusion is arranged at an angle with respect to said panel; and, said angle is larger than 45°.

6. The aerodynamic skirt of claim 5, wherein said angle is larger than at least one of 70° and 85°.

7. The aerodynamic skirt of claim 5, wherein said protrusion is arranged at least one of orthogonally with respect to said panel and horizontally when the aerodynamic skirt is mounted in said mounting orientation.

8. The aerodynamic skirt of claim 1, wherein the protrusion is an inward protrusion or an outward protrusion with respect to said mounting orientation.

9. The aerodynamic skirt of claim 1 further comprising an inward protrusion and an outward protrusion both arranged at said bottom end of said panel and arranged transversely with respect to said panel.

10. The aerodynamic skirt of claim 9, wherein said inward protrusion and said outward protrusion are configured symmetrically or asymmetrically with respect to said panel.

11. The aerodynamic skirt of claim 1 wherein:
said panel has a first length with respect to the driving direction;
said protrusion has a second length with respect to the driving direction; and,
said second length is smaller than said first length.

12. The aerodynamic skirt of claim 11, wherein at least one of:
a ratio of said second length of said protrusion and said first length of said panel is at least one of: at least 1/5 and at most 4/5; and,
said protrusion is positioned at a front end of said panel, at a rear end of said panel or spaced apart from both said front end of said panel and said rear end of said panel.

13. The aerodynamic skirt of claim 1, wherein said protrusion extends along a full length of said panel.

14. The aerodynamic skirt of claim 1, wherein at least one of:
said panel includes a first portion arranged in parallel to the driving direction; and,
said panel includes a second portion which converges forwardly with respect to the driving direction.

15. The aerodynamic skirt of claim 1, wherein at least one of:
said protrusion is attached to said panel via a welded connection; and,
said protrusion is formed at least one of: as one piece with said panel, by cold forming, and by bending.

16. The aerodynamic skirt of claim 1, wherein the vehicle is a trailer or a tractor-trailer-combination.

17. A vehicle comprising:
an aerodynamic skirt having a panel;
said aerodynamic skirt being configured to be mounted in a mounting orientation defining an orientation of said aerodynamic skirt with respect to a driving direction of the vehicle;
said panel being arranged vertically when said aerodynamic skirt is mounted in the mounting orientation;
said panel including a bottom end with respect to the mounting orientation; and,
said aerodynamic skirt including a protrusion at said bottom end arranged transversely with respect to said panel.

18. The vehicle of claim 17 further comprising:
a chassis; and,
said aerodynamic skirt being positioned under said chassis.

19. The vehicle of claim 17 further comprising:
a rear axle aggregate having at least one axle; and,
said aerodynamic skirt being positioned in front of said rear axle aggregate with respect to the driving direction.

20. The vehicle of claim 17, wherein the vehicle is a trailer or a tractor-trailer-combination.
